(19) United States
(12) Patent Application Publication
(10) Pub. No.: US 2006/0282472 A1
(43) Pub. Date: Dec. 14, 2006

(54) System and method for data transmission management

(75) Inventors: Chong-Khai Ng, Taipei (TW); Shih-Hsiung Weng, Taipei (TW)

Correspondence Address: EDWARDS & ANGELL, LLP, P.O. BOX 55874, BOSTON, MA, 02205, US

(73) Assignee: Inventec multimedia & Telecom Corporation, Taipei (TW)

(21) Appl. No.: 11/152,864

(22) Filed: Jun. 14, 2005

(51) Int. Cl. G06F 17/30

(52) U.S. Cl. 707/200

(57) ABSTRACT

A method and system for managing data transmission between an external memory and an internal memory of an electronic apparatus is provided. The system includes an interactive interface for outputting messages that indicate real-time storage status of the internal memory and external memory card. When an external memory card is inserted, the system automatically duplicates files stored in the internal memory to the external memory card, and deletes the files in the internal memory upon determining that the files have been successfully transferred to the external memory card by matching the file names of the files in the internal memory to the external memory card. The system further includes a clamping means for securely clamping the portion of the external memory card that is exposed outside the electronic apparatus to avoid unintentional detachment of the external memory card from the electronic apparatus.

### FIELD OF THE INVENTION

The present invention relates to a data transmission technique, and more particularly, to a system and method for managing data transmission between internal memory of an electronic apparatus and external memory.

### BACKGROUND OF THE INVENTION

Digital Still Camera (DSC) is an electronic apparatus used for capturing natural images and converting captured natural images into image files in digital format. The digital image files usually are large in size, so a very large memory capacity is needed to store them.

Moreover, card size digital still cameras have been developed to meet the demands for being compact and lightweight. The size of the motherboard thereof approximately equals a name card that is suitable for users to carry around.

However, one drawback of a card size digital camera is that it is usually provided with a 16 MB internal memory, which accommodates only about 80 low-resolution digital images, and even less for high-resolution images. A solution to this problem is to provide external removable memory card with large capacity, such as a CF card or a SD card that can be inserted into the card size digital camera. However, such approach would require a considerable amount of internal space of the card size digital camera to accommodate entirely the once-inserted external memory card, restricting the demanded size reduction of the card size digital camera. U.S. Pat. No. 6,208,380 has thus proposed a solution to address this problem as shown in FIG. 2A. The length of a slot module 70 is decreased, such that when an external memory card 30 is inserted therein, half of the card area is exposed outside the casing of a digital camera 100. This method provides a larger storage capacity for the camera 100 without adversely increasing its size, since the external card 7 is not completely inserted into the digital camera, and data in internal memory of the digital camera 100 can be transferred to the external memory card 30 for storage. When all data has been transferred to the external memory card 30, the data stored in the internal memory is deleted, so that the size of the digital camera can be greatly reduced while unlimited extended memory capacity can be achieved. Nonetheless, such design still has disadvantages, i.e. it lacks data transmission management functionality and a user-friendly interface to interact with the users. The machine itself controls all the data transmission managing process, which cannot provide usage status of the internal memory in real time to the user. In this case, the user is unable to determine that the internal memory is reaching its full capacity and insert the external memory card into the digital camera 100 in advance to reduce the time taken for data transmission. Additionally, in this patent, the data file stored in the internal memory is deleted once and for all. However, during the data transmission process, the data files originally stored in the internal memory may not be completely transferred to the external memory card for storage due to some reasons, thus once the not-yet-transferred image data is deleted, it will be lost permanently. Moreover, this design is applied to portable electronic information devices, when the user moves while operating the digital camera, vibration of the movement may cause the external memory card 30 to detach from the slot module 70, since half or more of the card size is exposed outside of the digital camera 100, resulting in incomplete data transfer.

Thus, a system for managing stable data transmission with a user-friendly interface is urgently in need.

### SUMMARY OF THE INVENTION

In the light of the forgoing drawbacks, an objective of the present invention is to provide a data transmission management system and method that provides an interactive interface for the user, which provides information such as real-time storage status of the internal storage unit and the externally connected storage unit, so that the user may be notified that the internal storage unit is reaching its full capacity, and inserts an external storage unit for duplication process in advance.

Another objective of the present invention is to provide a data transmission management system and method that automatically copies files stored in the internal storage unit to the external storage unit, and then deletes the files when it determines that the files are successfully copied to the external storage unit.

Still another objective of the present invention is to provide a data transmission management system that securely fastens the external storage unit to the electronic apparatus where at least a portion of the external storage unit is exposed outside of the electronic apparatus.

In accordance with the above objectives, the data transmission management method of the present invention comprises: detecting connection between the external storage unit and the electronic apparatus; duplicating files stored in the internal storage unit to the external storage unit upon said connection being detected; and determining whether the file names of the files in the internal storage unit match those stored in the external storage unit, wherein the files in the internal storage unit whose file names have respective matches in the external storage unit are automatically deleted from the internal storage unit, and the files in the internal storage unit whose file names do not have respective matches in the external storage unit are duplicated again from the internal storage unit to the external storage unit.

The data transmission management method of the present invention further comprises determining and displaying the currently available storage space of the internal storage unit and/or external storage unit on a display unit of the electronic apparatus.

The data transmission management system for managing data transmission between an internal storage unit in an electronic apparatus and an external storage unit in accordance with one embodiment of the present invention, comprises: a detection module for detecting connection between the external storage unit and the electronic apparatus; a microcontroller unit for receiving a message sent from the detection module notifying said connection being detected, duplicating files stored in the internal storage unit to the external storage unit, and determines and displaying the available storage space of the internal storage unit and/or the external storage unit on a display unit of the electronic apparatus; and a matching module for determining whether the file names of the files in the internal storage unit match those stored in the external storage unit and sending match results to the microcontroller unit, wherein the microcontroller unit delete the files in the internal storage unit whose file names have respective matches in the external storage unit based on the match results, and duplicate again the files in the internal storage unit to the external storage unit if the file names of the files do not have respective matches in the external storage unit based on the match results.

The data transmission management system further comprises a slot module for receiving the external storage unit; and a clamping means for exerting clamping force on a portion of the external storage unit that is exposed outside a casing of the electronic apparatus to securely fixing the external storage unit therewith.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram illustrating the structure and connection of a data transmission management system according to one embodiment of the present invention applied in a digital still camera;

FIG. 2A shows a schematic view of a conventional manner of connecting an external memory card to a digital still camera;

FIG. 2B shows a schematic view of connecting an external memory card to a digital still camera according to one embodiment of the present invention;

FIG. 3A shows the steps for implementing the data transmission management method; and

FIG. 3B shows the displayed screen contents corresponding to steps implemented in the method shown in FIG. 3A.

### DETAILED DESCRIPTION OF THE EMBODIMENTS

In the following embodiments, the system and method for data transmission management of an external storage unit of the present invention is applied to a card size digital still camera, providing a stable and automatic data transmission management for the digital still camera. It should be noted that the system and method for data transmission management of an external storage unit of the present invention is not limited to only digital cameras, but can be applied to any electronic information apparatus with externally connected storage unit for expanding storage capacity, especially portable electronic information apparatus. Embodiments of the system and method for data transmission management of an external storage unit of the present invention will be described in incorporation with the appended drawings.

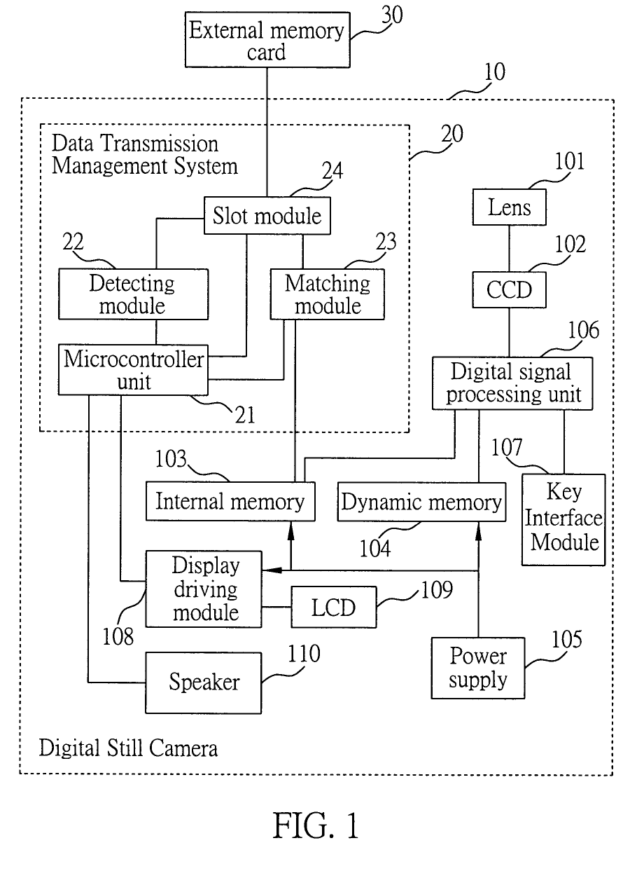

FIG. 1 is a schematic diagram for illustrating structure and connections within a data transmission management system 20 of the present invention applied in a digital still camera 10. As shown in FIG. 1, the digital still camera 10 captures natural images through lens 101, and converts the characteristics (e.g. light frequency etc.) of the captured natural images into current signals via a Charge Coupled Device (CCD) 102 for processing by a digital signal processing unit 106. Upon receiving the current signals from the CCD 102, the digital signal processing unit 106 decodes the current signals and reconstructs the original images captured by the lens 101, and stores, as files, the reconstructed images in an internal memory 103 or temporarily in a dynamic memory 104. During the digital still camera photographing and storing image files, user can set status of the image files stored therein via a key interface module 107, such that the user may choose whether to keep an image file in the internal memory 103 or delete it from the internal memory 103 permanently.

During photographing and data storage of the image files, power required for performing these processes is supplied from a power supply 105 to the digital still camera 10 and the data transmission management system 20. Additionally, the digital signal processing unit 106 continuously stores natural images captured through the lens 101 into the internal memory 103. In the process of storing image files, a microcontroller unit 21 of the data transmission management system 20 controls a display driving module 108 based on information related to image storing process performed by the digital signal processing unit 106, where the display driving module 108 drives a connected display unit (e.g. a LCD) 109 for displaying on its screen information such as the number of photos taken, used storage space and available storage space etc. Based on this reference information, the user will be able to determine whether to insert an external memory card 30 or continually use the internal memory 103 for image storage.

Generally, images stored in a digital camera tend to have large file sizes, with built-in storage unit, i.e. the internal memory 103, of the digital camera 10 small in size, for example, a 16 MB storage space capable of storing about 80 low resolution digital images and less than 10 high resolution images, the digital camera 10 usually requires one or more externally connected memory cards for memory expansion. When the microcontroller unit 21 detects that the internal memory 103 of the digital still camera 10 is reaching its full capacity, that is, the internal memory 103 is unable to store any more image files, the microcontroller unit 21 controls one or more output devices for outputting signals that reminds the user to insert an external memory card 30 by, for example, causing a speaker 110 to sound and/or display message on the LCD 109 through control of the display driving module 108. The microcontroller unit 21 then instructs a detecting module 22 to detect the status of a slot module 24 to determine whether the external memory card 30 has been inserted into the slot module 24. Once the user has inserted the external memory card 30 therein, the detecting module 22 sends a signal to the microcontroller unit 21. The microcontroller unit 21 then instructs the display driving module 108 for displaying on the LCD 109 a message indicating that the external memory card 30 has been found, so that the user is informed of proper insertion of the external memory card 30. This will ensure that the external memory card 30 be inserted properly to avoid the situation of unsuccessful data transfer due to improper card insertion. The microcontroller unit 21 then outputs the image files stored in the internal memory 103 to the external memory card 30 for storage via the slot module 24 acting as the transmission interface. After transmission of image files, a matching module 23 compares file names stored in both the internal memory 103 and the external memory card 30. If a file name of a file is determined to be in both of the internal memory 103 and the external memory card 30, the file in the internal memory 103 is automatically deleted to vacate more storage spaces. Additionally, the user may set in advance that a certain file is to be refrained from removal. In this case, the microcontroller unit 21 drives the speaker 80 to make a warning sound while displaying the image on the LCD 109, so that the user can decide whether he now wants to delete it from the internal memory 103 or not. This provides more flexibility for the removal process.

Although in the above embodiment, the key interface module 107, the display driving module 108, the LCD 109, and the speaker 110 are shown as part of the digital still camera 10 and shared between the digital still camera 10 and the data transmission management system 20 of the present invention, in another embodiment, these components can also be exclusive for the data transmission management system 20.

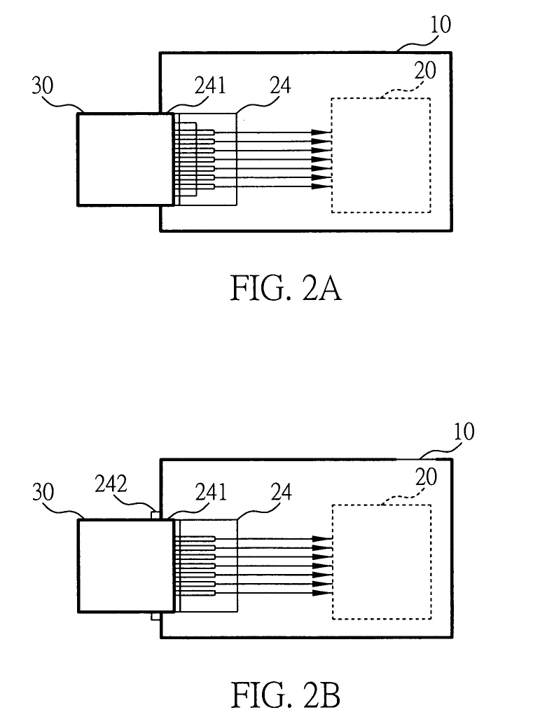

FIG. 2B shows a schematic view of connecting the external memory card 30 to the digital still camera 10 according to one embodiment of the present invention

As shown in FIG. 2B, the slot module 24 comprises a guiding groove 241 and a clamping structure 242. It should be noted that both FIG. 2B is a simplified schematic diagram for illustrating the basic principles of the present invention, thus the components shown may not drawn in accordance with physical shapes, scale and quantities.

The slot module 24 and the guiding groove 241 are fixed to the inside of the casing of the digital still camera 100. As shown in FIG. 2B, the length of the guiding groove 241 is a fraction of the length of the external memory card 30, for example, ⅕ or ⅙. The external memory card 30 is inserted from outside of the digital still camera 100 into the guiding groove 241 until electrical terminals 301 of the external memory card 30 comes in contact with electrical terminals 243 of the slot module 24. At the same time, the clamping structure 242 exerts clamping forces onto the external memory card 30 to stably position the external memory card 30. Various units and modules in the data transmission management system 20 and the digital still camera 10 can then start performing the operations described above.

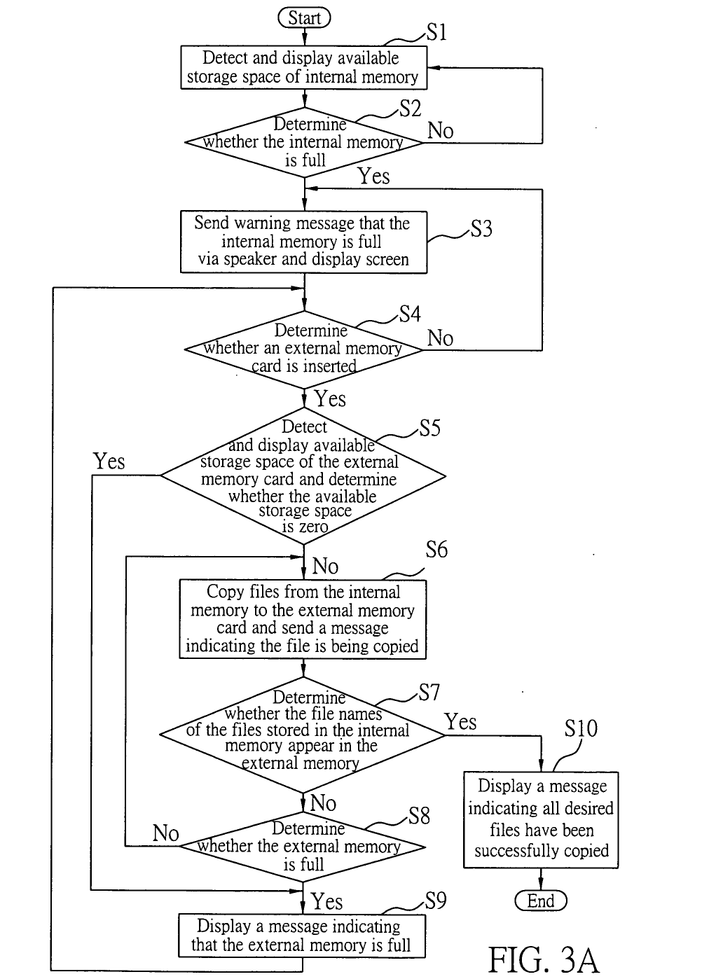

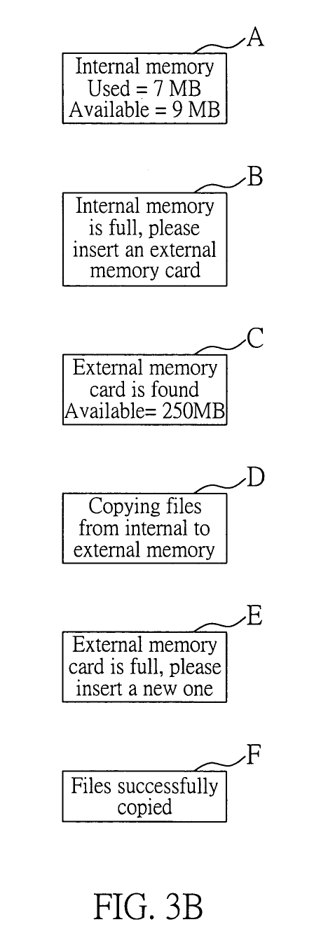

The following descriptions conjointly refer to FIGS. 3A and 3B, where FIG. 3A shows the steps for implementing the data transmission management method and the displayed screen contents corresponding to the steps implemented in FIG. 3A are shown in FIG. 3B. The user turns on the power supply 105 to provide power to the digital camera for photographing. First, in step S1 of FIG. 3A, the microcontroller unit 21 determines the storage status of the internal memory 103 and displays the result on the LCD 109 driven by the display driving module 108, as shown in exemplary screen content A in FIG. 3B, for example, respective size of used and empty memory. Then, goes to step S2.

In step S2, the microcontroller unit 21 determines whether the internal memory 103 has reached its storage capacity and can no longer store any image file. If so, then executes step S3; else, returns to step S1 so that the microcontroller unit 21 continues to determine and display the storage status of the internal memory 103.

In step S3, the microcontroller unit 21 sends a warning signal to indicate that the internal memory 103 is full, which causes the LCD 109 to display a screen content B via the display driving module 108 and/or the speaker 110 to make a warning sound in order to remind the user that the storage of the internal memory 103 is full and another external memory card 30 is needed to be inserted for further storage. Then, performs step S4.

In step S4, the detecting module detects whether an external memory card has been inserted, if an external memory card is detected, performs step S5; else, returns to step S3.

In step S5, the microcontroller unit 21 determines the available storage space of the external memory card 30 and sends an instruction to the display driving module 108 for displaying a message indicating that the external memory card 30 is found and the available storage space thereof on the LCD 109, as shown in exemplary screen content C. If the available storage space of the inserted memory card is zero, then performs step S9; else goes to step S6.

In step S6, the microcontroller unit 21 starts duplicating files stored in the internal memory 103 to the external memory card 30 and a message indicating that copy is in progress is displayed on the LCD 109, as shown in exemplary screen content D. Next, goes to step S7.

In step S7, the matching module 23 determines whether the files names of the files in the internal memory 103 match those in the external memory card 30, i.e. whether a successful duplication has been achieved. If there is a match, go to step S110; else, goes to step S8.

In step S8, since a duplication of the files is unsuccessful, the microcontroller unit 21 determines whether the external memory card 30 is full, if so, goes to step S9; else, returns to step S6 to perform the duplication process again.

In step S9, a warning message indicating that the external memory card is full is displayed on the LCD 109, as shown in exemplary screen content E, and/or the speaker 110 is sounded in order to remind the user that the storage of the external memory card 30 is full and another external memory card 30 should be inserted for further storage. Then, returns to step S4.

In step S10, a message is displayed on the LCD 109 as shown in exemplary screen content F to indicate that all desired files are successfully copied.

It should be apparent to those skilled in the art that the above description is only illustrative of specific embodiments and examples of the present invention. The present invention should therefore cover various modifications and variations made to the herein-described structure and operations of the present invention. For example, in an alternative embodiment, after determining the file names are matched, the data transmission management method may further perform a step of determining whether the file was previously selected by the user to be refrained from automatic deletion. In such a case, the selected file will not be deleted even if a copy of the file exists in the external memory card. Therefore, the scope of the present invention should be defined only by the following appended claims.

What is claimed is:

1. A method for managing data transmission between an internal storage unit in an electronic apparatus and an external storage unit, comprising the following steps of:
detecting connection between the external storage unit and the electronic apparatus;
duplicating files stored in the internal storage unit to the external storage unit upon said connection being detected; and
determining whether the file names of the files in the internal storage unit match those stored in the external storage unit,
wherein the files in the internal storage unit whose file names have respective matches in the external storage unit are automatically deleted from the internal storage unit, and the files in the internal storage unit whose file names do not have respective matches in the external storage unit are duplicated again from the internal storage unit to the external storage unit.

2. The method of claim 1, further comprising:
determining available storage space in the internal storage unit and outputting a message to indicate said available storage space.

3. The method of claim 2, further comprising:
outputting a message to indicate that the internal storage unit has reached its storage capacity upon determining that the available storage space of the internal storage unit is zero.

4. The method of claim 1, wherein after determining that the file names of the files in the internal storage unit do not have respective matches in the external storage unit, the method further comprising:
determining whether the external storage unit has reached its storage capacity; and
outputting a message to indicate that the external storage unit has reached its storage capacity.

5. The method of claim 1, wherein upon detecting said connection a message is outputted to indicate that the external storage device is properly connected to the electronic apparatus.

6. The method of claim 1, wherein the electronic apparatus is a digital still camera.

7. The method of claim 1, wherein the external storage unit is one selected from the group consisting of a Compact Flash (CF) memory card, a Secured Digital (SD) memory card, a Smart Media (SM) card, and a Multi-Media (MM) card.

8. The method in any one of the claims 2 and 5, wherein the step of outputting a message is at least one of displaying a message on a display unit of the electronic apparatus and sounding a speaker of the electronic apparatus.

9. The method of claim 8, wherein the display unit is a Liquid Crystal Display (LCD).

10. The method of claim 1, wherein during said automatic deletion of files from the internal storage unit, a file selected by a user in advance may be refrained from deletion.

11. A system for managing data transmission between an internal storage unit in an electronic apparatus and an external storage unit, comprising:
a detection module for detecting connection between the external storage unit and the electronic apparatus;
a microcontroller unit for receiving a message sent from the detection module notifying said connection being detected and duplicating files stored in the internal storage unit to the external storage unit; and
a matching module for determining whether the file names of the files in the internal storage unit match those stored in the external storage unit and sending match results to the microcontroller unit,
wherein the microcontroller unit delete the files in the internal storage unit whose file names have respective matches in the external storage unit based on the match results, and duplicate again the files in the internal storage unit to the external storage unit if the file names of the files do not have respective matches in the external storage unit based on the match results.

12. The system of claim 11, wherein the microcontroller unit further determines the available storage space in the internal storage unit and sends a message to display the available storage space of the internal storage unit.

13. The system of claim 12, wherein the microcontroller unit sends a message to indicate that the internal storage unit has reached its storage capacity upon determining that the available storage space of the internal storage unit is zero.

14. The system of claim 11, wherein after determining that the file names of the files in the internal storage unit do not have respective matches in the external storage unit, the microcontroller unit further determines whether the external storage unit has reached its storage capacity, and sends a message to indicate that the external storage unit has reached its storage capacity.

15. The system of claim 11, wherein when the detecting module detects the external storage unit is connected, the microcontroller unit outputs a message to indicate that the external storage unit has been properly connected.

16. The system of claim 11, wherein the electronic apparatus is a digital still camera.

17. The system of claim 11, wherein the external storage unit is one selected from the group consisting of a Compact Flash (CF) memory card, a Secured Digital (SD) memory card, a Smart Media (SM) card, and a Multi-Media (MM) card.

18. The system in any one of the claims 12 to 15, wherein the message is outputted via at least one of a display unit of the electronic apparatus and a speaker of the electronic apparatus.

19. The system of claim 18, wherein the display unit is driving by a display driving module, which receives instructions from the microcontroller unit.

20. The system of claim 18, wherein the display unit is a Liquid Crystal Display (LCD).

21. The system of claim 11, further comprising:
a slot module for receiving the external storage unit; and
a clamping means for exerting clamping force on a portion of the external storage unit that is exposed outside a casing of the electronic apparatus to securely fixing the external storage unit therewith.

22. The system of claim 11, wherein during said automatic deletion of files from the internal storage unit, a file selected by a user in advance may be refrained from deletion.
